(19) United States
(12) Patent Application Publication
(10) Pub. No.: US 2009/0322651 A1
(43) Pub. Date: Dec. 31, 2009

(54) DISPLAY DEVICE AND DISPLAY METHOD FOR THE PRESENTATION OF VISUAL CONTENT

(76) Inventor: Thomas Tennagels, Dusseldorf (DE)

Correspondence Address: Clements Bernard PLLC, 1901 Roxborough Road, Suite 250, Charlotte, NC, 28211, US

(21) Appl. No.: 12/438,634

(22) PCT Filed: Aug. 23, 2007
(86) PCT No.: PCT/EP07/58782

§ 371 Date: Feb. 24, 2009

(30) Foreign Application Priority Data
Aug. 26, 2006 (DE) 10 2006 040 119.0

(51) Int. Cl. G09G 5/00

(52) U.S. Cl. 345/1.3

(57) ABSTRACT

The invention relates to a display device for the presentation of visual content at big events and to a display method for the presentation of such content. The device comprises a plurality of display elements (12) connected with carrier elements (13), the display elements being disposed in rows (14). Furthermore, the display device comprises a carrier rail (16) for mechanically fastening the carrier elements (13) and to supply the display elements (12) with voltage and control signals. The rows (14) of the display elements (12) extend at least partially in several directions (18, 20), starting from the carrier rail (16).

The inventive display method for the presentation of visual content transmits the control signals originating front the carrier rail (16) via a feed element (22) in a direction (18) of a display element row (14), wherein the signals are deflected at a first end (4) of the display element row (14) through a firs end cap (36) in the direction of a second end (42) of the display element row (14), then deflected at the second end (42) of the display element row (14) by a second end cap (38) in the direction of the carrier rail (16), and deflected back into the carrier rail (15) via the feed element (22).

The invention refers to a display device as well as a display method for the presentation of optical content, in particular at big events.

At big events, such as music or sports events, for example, very large display devices are typically used to present optical content. This optical content may include text, pictures, videos, optical effects or the like. In general, such display devices are embodied as LED walls. Here, a single LED, or an RGB set of LEDs for presentations in color, represents a pixel, the overall picture being formed by a plurality of pixels. In most cases the LEDs are arranged vertically in rows, one below the other, with a plurality of vertical rows being arranged horizontally and side by side so that an LED wall is formed. Depending on the number of rows arranged side by side or on the length of the individual rows, the overall size of the LED wall can be varied. This allows to adapt the display device to the specific needs of the event. At big events such LED walls may feature a height and a width of several meters.

Usually, the individual pixels are controlled digitally, for example through DMX or DVI signals.

EP 1 635 310 A2 describes such a display device, wherein the individual rows of display elements are disposed in transparent tubular carrier elements connected to a frame. The carrier elements are detachable from the frame. A combination of a plurality of frames allows to construct larger display elements.

Such an arrangement has the drawback that the shape of the display device depends on the form of the frame elements used. Thus, it is not possible to design the shape of the display device in a flexible manner. Moreover, it is necessary to fix the frame elements. Holding lugs are provided for that purpose on their upper face, from which the topmost frame element may be suspended, for example. This requires a horizontally extending carrier rail which has to run above the topmost frame element. The shape of the top edge of the display device is thus determined by the extension of this carrier rail and also allows no flexible design.

EP 1 293 955 A2 describes a display device in which the individual display elements are arranged in a support frame and flexible elements can be used to movably interconnect a plurality of such support frames. The entire display device is suspended at the top from a rail, using a suspending device.

Such a display device also has the drawbacks of the display device of EP 1 635 310 A2, so that its outer contour can not be flexibly adapted to the local conditions.

US 2003/0146882 A1 describes a display device formed by a plurality of display units that may be interconnected so that the size of the display device can be changed. The display units are of a square design and all have the same shape so that the display device can be assembled in the manner of a matrix.

DE 695 19 380 T2 describes a display system wherein a control signal is supplied at an input to a row of display elements, which at the end of the first display element row is directed to the input of the second display element row. Starting from the input of the second display element row, the control signal propagates towards the end of the second display element row from where it is again directed towards the beginning of another display element row. The method described is repeated until the control signal is supplied to a signal output.

It is an object of the invention to provide a display device whose size and outer contour can readily be adapted to the local conditions. Further, it is an object of the invention to provide a display method for the presentation of optical content that allows for a simple and quick adaptation of the size and the outer contour of a display device.

The object is achieved with the features of the device claim 1 as well as the features of the method claim 22.

A display device for the presentation of optical content at big events comprises a plurality of display elements connected with carrier elements. The display elements are disposed in rows. Moreover, the display device has a carrier rail for a mechanical mounting of the carrier elements and for the supply of electric voltage and control signals to the display elements. From the carrier rail, the rows of display elements extend at least partly in several directions.

This allows to readily adapt the size and the outer contour of the display device to the specific requirements of an event. For example, the rows of display elements may extend vertically upwards from a horizontally disposed carrier rail, but also vertically downwards. The length of each row of display elements may be adapted individually, it being possible for the length of a row of display elements extending downwards from a carrier rail to differ from the length of the row of carrier elements extending upwards from the carrier rail.

Since the display device is no longer suspended hanging down from a rail, also the upper outer contour of the display device can be designed in a flexible and individual manner. In particular, it is possible to set creative accents by an irregular or asymmetric design of the outer contour of the display device. The carrier elements with which the display elements are connected also have a static function, among others, so that the display elements are supported by the carrier rail against the forces of gravity or possible wind forces occurring. Further, the carrier elements can be configured such that they completely enclose the display elements so that a protection against effects of the weather, such as rain, is also guaranteed.

In particular, no further supporting element is required for the display device, except for the carrier wall.

In a preferred embodiment, the carrier elements are connected with the carrier rail via a feed element. This feed element serves the mechanical connection of the carrier elements with the carrier rail. On the other hand, the feed element establishes the electric connection of the display elements at the carrier elements with the carrier rail.

To achieve this, the carrier rail may comprise voltage supply contacts as well as control signal supply contacts for the supply of the display elements. These contacts of the carrier rail may be connected with the feed element which in turn comprises electric lines and electric contacts for transmitting the electric voltage and the control signals to the display elements.

In a particularly preferred embodiment, the ends of the rows of display elements are each provided with an end cap for redirecting the control signals. It is particularly preferred to provide this end cap at both ends of the rows of display elements.

The control signals for the display elements may include a serial data signal. Moreover, the control signals may include DMX or DVI signals. It is particularly preferred for the display elements, especially each display element, to comprise a control chip processing the control signals.

In a particularly preferred embodiment, the face of the feed element directed to the viewer also has a display element, especially a plurality of display elements. Thus, it is guaranteed that the feed element will not cause a gap in the picture presented.

It is further preferred to provide a connecting device between the feed element and the carrier elements so as to establish a mechanical connection with the carrier elements and an electric connection with the display elements.

The display elements may, for example, be LEDs and/or LED clusters. An LED cluster may be formed as a plurality of LEDs provided on a carrier device.

Each Individual LED may comprise a separate control chip. It is also possible for an LED cluster to comprise only one chip for a plurality of LEDs. The control chip will then control these LEDs within the LED cluster either individually or in common.

For color pictures, a display element may especially comprise three LEDs of the colors red, green and blue. These three LEDs represent an image pixel, with the complete picture being composed from a plurality of pixels.

It is particularly preferred to connect a carrier element with a plurality of display elements. For example, it is possible to connect a larger number (10, 20, 30 etc.) of LEDs with one carrier element. Preferably, the display elements are arranged in rows on the carrier elements. Such a carrier element may have a standard size of several centimetres so that a plurality of carrier elements can be assembled to a desired length forming a row of display elements.

Further, it is possible to mechanically interconnect a plurality of carrier elements or several rows of display elements at another site different from a carrier rail so as to comprise them into a unit. Here, as before, the individual display element rows are controlled separately. The comprised display element rows form display panels that can be combined to form an overall picture. The mechanical connection of the individual display element rows may be made at any optional point.

Moreover, it is possible to provide connector elements for the electric and mechanic connection of the carrier elements. These connector elements could be configured as bayonet locks, for example.

A tubular design of the carrier elements is particularly preferred. Such a tubular carrier element may have a circular cross section, but it may also be ellipsoidal or angular. The face of the carrier elements directed towards the onlooker is transparent, whereas it should be noted for an angular carrier element to avoid corners at the transparent face that could blur the picture by refraction.

The carrier rail may extend both in a horizontal direction and inclined under any angle with respect to the horizontal. Further, it is possible to orientate the carrier rail vertically.

The method of the present invention for the presentation of optical content is specifically suited for operating a display device of the type described above, but it may also be used in combination with other display devices.

Starting from the carrier rail, the control signals are directed via the feed element into one direction of a display element row. At a first end of the display element row, the signals are redirected by a first end cap towards a second end of the display element row. At the second end of the display element row, the signals are redirected towards the carrier rail by a second end cap and are fed back into the carrier rail via the feed element.

It is particularly preferred that the supply of control signals to the display elements is effected via a control signal line between the first and the second end cap. Thus, no control signals are tapped by the display elements along the path of the control signals starting from the carrier rail towards the first end cap. Only after the control signals have been redirected by the first end cap will the display element adjacent the first end cap tap the control signal intended for the same and will pass the control signals for the following display elements on to the same. The tapping of the control signals is controlled by the control chip on every display element.

This process continues until the control signal has reached the first display element of the feed element. The control chip of the display element of the feed element can then determine automatically how many display elements are present in the display element row between the first end cap and the feed element.

Thereafter, the control signal is passed on through further display elements towards the second end cap and is redirected by the same towards the carrier rail. Due to the returning control signal at the carrier rail, it is then possible to determine the number of display elements present in the second display element row between the second end cap and the feed element.

It is possible, for example, starting from a horizontally directed carrier rail, to conduct the control signal in a vertical direction upwards along a row of display elements, the control signal being redirected downwards at the top end of the display element row by the first end cap. On this way down, the individual display elements tap the respective control signal intended for them. After the number of display elements arranged in the upward and downward directions starting from the carrier rail has been determined as described before, the control signal is redirected upwards towards the carrier rail by a second end cap at the lower end of the display element row.

Thus, the length of a display element row can be determined in both directions, starting from the carrier rail. This process is repeated for all display element rows so that the outer contour of the display device can be determined from the respective number of the display element present between the feed element and the first and second end cap of each display element row. This process has to take place only once after the display device has been set up, so that the size and the outer contour of the display device is determined. If the display device remains unaltered, there Is no need to repeat this process when the display device is operated.

The method of the present invention allows for a flexible design of the size and the outer contour of the display device and to modify it in a simple manner. The configuration of the display device is achieved automatically. For example, the exact position and the number of LED pixels can be represented precisely on a PC so that an exact transmission of the picture content becomes possible.

In particular, it is possible to design the outer contour of the display device optionally without the configuration of the display device being impaired.

Alternatively, it is possible to configure the display device manually.

To allow for shorter current paths to the display elements, electricity is supplied directly from the carrier rail to the elements and not via the end caps.

The following is a detailed description of preferred embodiments of the invention with reference to the Figures.

In the Figures:

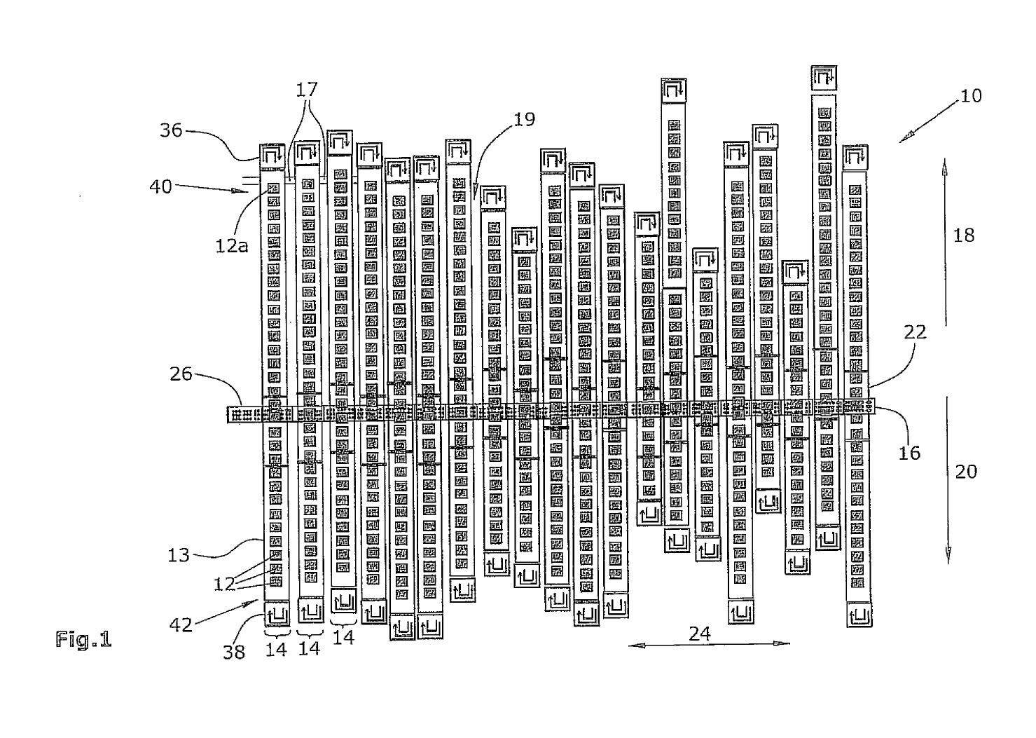

FIG. 1 is a front view of the display device of the present invention;

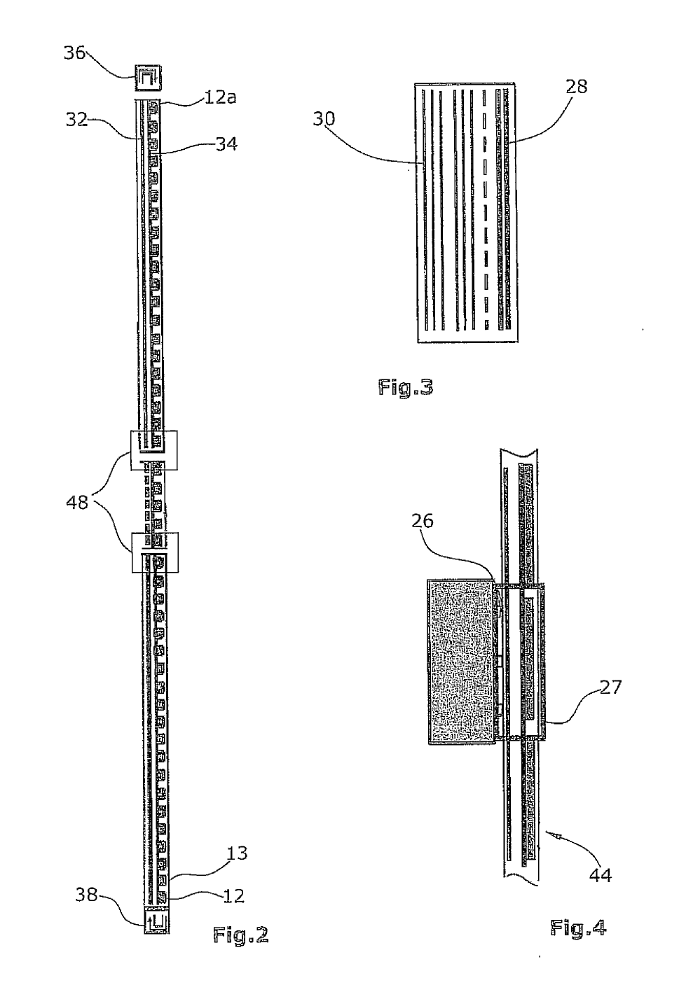

FIG. 2 is a side elevational view of the display device of the present invention;

FIG. 3 is a rear view of the feed element;

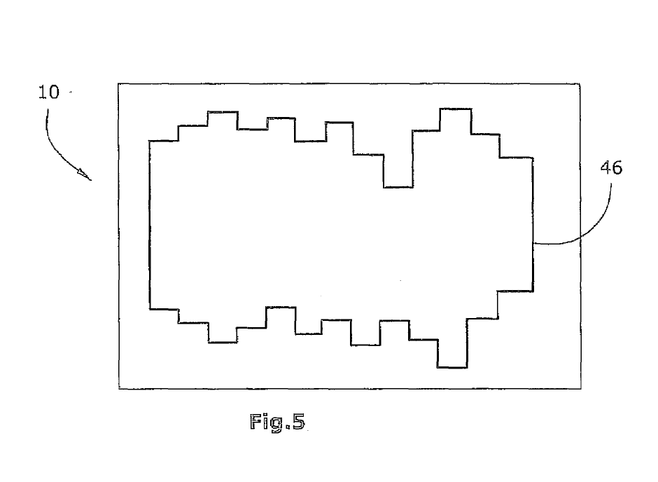

FIG. 4 is a side elevational view of the carrier rail with a feed element, and

FIG. 5 is a schematic view of the outer contour of the display device.

FIG. 1 illustrates a display device 10 for the presentation of optical content comprising a plurality of display elements 12 connected with carrier elements and arranged in rows 14. The display device 10 comprises a carrier rail 16 for the mechanical fastening of the carrier elements 13 as well as for the supply of the display elements 12 with electric voltage and control signals. The rows 14 of the display elements 12 extend from the carrier rail 16 both vertically upwards 18 and vertically downwards 20. The carrier rail 16 extends substantially horizontally. The carrier elements 13 are connected with the carrier rail 16 via a feed element 22. As illustrated in FIG. 3, the latter comprises electric lines 30 and electric contacts to transmit the control signals from the carrier rail 16 to the display elements 12. As shown in FIG. 4, the carrier rail has spring contacts 26 for supplying control signals and voltage to the display elements 12. These spring contacts 26 are connected with the lines 28, 30 of the feed element 22.

The feed elements 22 are connected with the carrier elements 13 via connecting elements 48, as illustrated in FIG. 2. The connecting elements 48 establish both a mechanical and an electrical connection with the carrier elements 13, which in turn are electrically connected with the display elements 12.

At the top end 40 of each display element row 14 a first end cap 36 is provided, whereas a second end cap 38 is provided at the bottom end of each display element row 14.

The side 44 of the feed element 22 directed towards the onlooker is also provided with display elements 12. Like the other display elements 12, these may also be LEDs or LED clusters. The LED elements 12 are connected with the feed element 22 via retaining clamps 27. Each LED element has its own control chip comprising a serial controller.

The carrier elements 13 are circular tubes fully enclosing the LED elements so that these are protected against climatic influences. In addition, the carrier elements 13 have a static support function so that no other fastening means except for the carrier rail 16 is required for the display element rows 14. With a suitable structure of the tubular carrier elements 13, it is possible to create LED walls several meters high.

In addition, it is possible for example, to provide the top side of the display element rows 14 with a stiffening element 17 by which the display element rows 14 are supported against each other. This serves to stiffen the structure, not as a suspension for the display device 10.

In the method of the present invention the display device 10 is supplied with voltage and control signals via the carrier rail 16. The supply of control signals is such that the same are directed vertically upwards 18 on a first control signal line 32 from the carrier rail 16 via the feed element 22. At the first end 40 of the display element row 14, the control signals are redirected by the first end cap 36 towards a second end 42 of the display element row 14 and conducted towards the feed element 22 on a second control signal line 34. The second control signal line 34 may be formed on the display elements 12 or the carrier elements 13. After the control signal has been redirected by the first end cap 36, the first display element 12a adjacent the first end cap 36 taps the control signal for this first display element 12a and passes the control signals for the following display elements 12 on to these.

The display elements 12 of the feed element 22 also receive their control signals via the second control signal line 34 that starts from the first end cap 36.

From the incoming control signals at the feed element 22, the control chip of the topmost display element 12 of the feed element 22 automatically determines the number of display elements 12 in the display element row 14 between the first end cap 36 and the feed element 22.

In the further course, the control signals are conducted on towards the second end 42 of the display element row 14. Again, the display elements 12 tap the respective control signals intended for them and pass the control signals for the other display elements 12 on to the same.

At the second end 42 of the display element row 14 the control signals are redirected towards the carrier rail 16 by the second end cap 38.

Due to the control signal returning from the second end cap 38 to the carrier rail 16, the number of display elements 12 present in the display element row 14 between the and cap 38 and the feed element 22 is automatically determined. Thereafter, the control signals are returned into the carrier rail 16 via the feed element 22.

Based on the respective number of display elements 12 present between the feed element 22 and the first 36 and second end cap 38 of each display element row 14, the outer contour 46 of the display device 10 is then determined. As illustrated in FIG. 5, the same may be transmitted to a PC so that the exact position and the exact number of LED elements can be recorded. This allows for an exact transmission of the picture content to the display device.

To avoid extended current paths the display elements 12 are supplied with electric voltage from the carrier rail 16 towards the first 36 and the second end cap 38 via a voltage supply line 28 without first conducting the current via the end caps 36, 38.

The display element rows 14 are typically arranged mutually parallel and may have different lengths as illustrated in FIG. 5. This allows for a very individual and flexible design of the outer contour and the size of the LED wall.

Further, the display element rows 14 may be arranged spaced from each other so that a gap 19 is formed between the individual display element rows 14. Since the LED wall 10 may possibly take very large dimensions, it offers a large surface for wind to attack should it be set up in the open. By providing gaps 19 between the display elements 14, the susceptibility of the LED wall 10 to wind is reduced.

1-29. (canceled)

30. A display device for the presentation of optical content at big events, comprising
a plurality of display elements arranged in rows and connected with carrier elements, and
a carrier rail for the mechanical fastening of the carrier elements and for the supply of electric voltage and control signals to the display elements,
wherein
the rows of the display elements extend from the carrier rail at least partly in several directions.

31. The display device of claim 30, wherein the carrier elements are connected with the carrier rail through a feed element.

32. The display device of claim 30, wherein the display elements comprise one of LEDs and LED clusters.

33. The display device of claim 30, wherein the rows of display elements extend parallel to each other.

34. The display device of claim 30, wherein the rows of display elements extend vertically upward and vertically downward from the carrier rail.

35. The display device of claim 30, wherein the carrier rail extends substantially horizontally.

36. The display device of claim 30, wherein the carrier rail comprises voltage supply contacts and control signal supply contacts for the supply of the display elements.

37. The display device of claim 36, wherein the voltage supply contacts and the control signal supply contacts of the carrier rail are connected with the feed element.

38. The display device of claim 37, wherein the feed element comprises electric lines and electric contacts to pass on the electric voltage, as well as electric lines and electric contacts to pass on the control signals to the display elements.

39. The display device of claim 30, wherein at the end, in particular at both ends, of the rows of the display elements an end cap is provided for the redirection of the control signals.

40. The display device of claim 30, wherein the display elements comprise a first control signal line for passing the control signals on towards a first end cap, and a second control signal line for passing the control signals on towards a second end cap.

41. The display device of claim 30, wherein the control signals include a serial data signal.

42. The display device of claim 30, wherein the display elements comprise control chips.

43. The display device of claim 31, wherein the feed element comprises a display element on its side directed towards the onlooker.

44. The display device of claim 30, wherein, between the feed element and the carrier elements, a connecting device is provided for the mechanical connection with the carrier elements and for the electrical connection with the display elements.

45. The display device of claim 30, wherein the display element rows differ in length.

46. The display device of claim 30, wherein a plurality of display elements is connected with one carrier element.

47. The display device of claim 30, wherein a display element row is formed from a plurality of carrier elements with display elements.

48. The display device of claim 47, wherein the carrier elements are electrically and mechanically interconnected by means of connecting elements.

49. The display device of one claim 30, wherein the carrier elements are tubular in shape.

50. The display device of claim 30, wherein the carrier elements are substantially transparent, especially on the side facing the onlooker.

51. A display method for the presentation of optical content, especially using the display device of claim 30, wherein
the control signals are conducted from a carrier rail via a feed element in one direction of a display element row,
at a first end of the display element row, the control signals are redirected towards the second end of said display element row, especially by a first end cap,
at the second end of the display element row, the control signals are redirected towards the carrier rail especially by a second end cap, and
the control signals are returned into the carrier rail via the feed element.

52. The display method of claim 51, wherein the supply of control signals to the display elements is effected via the second control signal line between the first and the second end cap.

53. The display method of claim 52, wherein the first display element adjacent the first end cap taps the control signal for this first display element from the second control signal line and passes the control signals for the following display elements to these.

54. The display method of claim 51, wherein the display elements are supplied with electric voltage from the carrier rail directly in the direction of the first and the second end cap via a voltage supply line.

55. The display method of claim 51, wherein the display element of the feed element receives its control signals via the second control signal line coming from the first end cap.

56. The display method of claim 55, wherein the control chip of the display element of the feed element automatically determines the number of display elements present in a display element row between the first end cap and the feed element.

57. The display method of claim 51, wherein, based on the control signal returning from the second end cap to the carrier rail, the number of display elements present in a display element row between the second end cap and the feed element is determined.

58. The display method of claim 56, wherein the outer contour of the display device is determined based on the respective number of display elements present between the feed element and the first and second end cap of each display element row.
